(19) United States
(12) Patent Application Publication
(10) Pub. No.: US 2013/0052445 A1
(43) Pub. Date: Feb. 28, 2013

(54) COMPOSITE OXIDE FILM AND METHOD FOR PRODUCING THE SAME

(71) Applicants: Satoshi NAKADA, Wako-shi (JP); Masayuki SUGAWARA, Wako-shi (JP)

(72) Inventors: Satoshi NAKADA, Wako-shi (JP); Masayuki SUGAWARA, Wako-shi (JP)

(73) Assignee: HONDA MOTOR CO., LTD., Tokyo (JP)

(21) Appl. No.: 13/591,568

(22) Filed: Aug. 22, 2012

(30) Foreign Application Priority Data
Aug. 31, 2011 (JP) 2011-188720

(51) Int. Cl. B32B 9/00; B05D 3/10; B05D 3/02; B32B 5/00; B05D 1/36

(52) U.S. Cl. 428/220; 427/343

(57) ABSTRACT

Onto a substrate, a first material containing one of elements A and B is supplied, and an oxidant is supplied to form a first layer containing an oxide of the one of the elements A and B. Then, a second material containing the other of the elements A and B is supplied, and an oxidant is supplied to form a second layer containing an oxide of the other of the elements A and B. The steps are repeated to prepare a stack of a plurality of the first layers and a plurality of the second layers. Furthermore, the substrate and the stack are subjected to a heat treatment to produce a composite oxide film containing A_{X}B₆O._{_{—}}_{.5X+12} (6≦X≦30).

### CROSS-REFERENCE TO RELATED APPLICATION

This application is based upon and claims the benefit of priority from Japanese Patent Application No. 2011-188720 filed on Aug. 31, 2011, of which the contents are incorporated herein by reference.

### BACKGROUND OF THE INVENTION

1. Field of the Invention

The present invention relates to a composite oxide film and a method for producing the same, and more specifically to a film of a composite oxide containing a trivalent element A and a tetravalent element B represented by the composition formula of A_{X}B₆O_{1.5X+12} (6≦X≦30) and a method for producing the same.

2. Description of the Related Art

In a solid oxide fuel cell, a solid electrolyte is sandwiched between an anode and a cathode, and thus-obtained electrolyte electrode assembly is interposed between a pair of separators to form a unit cell. The solid electrolyte is composed of an oxide ion (O²⁻) conductor, and specifically a stabilized zirconia is known as the conductor. However, the stabilized zirconia exhibits a sufficient oxide ion conductivity only at a high temperature, and therefore the solid oxide fuel cell utilizing the stabilized zirconia has to be used at the high temperature disadvantageously.

In view of this problem, an apatite-type oxide has attracted much attention. The apatite-type oxide exhibits an excellent oxide ion conductivity in the c-axis direction of the crystal structure. Therefore, in the case of using the apatite-type oxide for the solid electrolyte, when the c-axis direction is aligned parallel to the thickness direction of the solid electrolyte between the cathode and the anode, oxide ions can be readily transferred, whereby the resultant solid oxide fuel cell can have an excellent power generation property.

A method for producing the solid electrolyte composed of the apatite-type oxide is known, for example, from Japanese Patent No. 3934750. However, in this method, the apatite-type oxide is obtained in the form of a polycrystal, the c-axes of the crystal grains being randomly oriented. Such a polycrystal exhibits an isotropic oxide ion conduction, so that it is difficult to achieve a sufficient oxide ion conductivity in the polycrystal.

The apatite-type oxide can be obtained in the form of a monocrystal or a uniaxially oriented polycrystal by technologies proposed in Japanese Patent No. 3985144 and Japanese Laid-Open Patent Publication Nos. 2004-244282 and 2011-037662.

### SUMMARY OF THE INVENTION

In the technology described in Japanese Patent No. 3985144, a compact is prepared and then heated or cooled with a temperature gradient. Therefore, it is difficult to obtain a thin film usable as the solid electrolyte film.

In the technology described in Japanese Laid-Open Patent Publication No. 2004-244282, an apparatus for generating a strong magnetic field is required, thereby resulting in an increased equipment investment. In addition, also in this technology, it is difficult to obtain the thin film.

In the technology described in Japanese Laid-Open Patent Publication No. 2011-037662, a material powder is vitrified at a high temperature and then crystallized by a heat treatment. Because of the use of the vitrified intermediate, it is difficult to obtain an oxide with a desired composition ratio. Thus, it is also difficult to achieve a sufficient oxide ion conductivity.

A principal object of the present invention is to provide a composite oxide film having a desired composition ratio.

Another object of the present invention is to provide a composite oxide film having a small thickness.

A further object of the present invention is to provide a method for easily producing a composite oxide film having a desired composition ratio.

According to an aspect of the present invention, there is provided a composite oxide film, which has a thickness of 50 to 500 nm and comprises a composite oxide represented by the composition formula of AₓB₆O_{1.5X+12} (6≦X≦30) containing a trivalent element A, a tetravalent element B, and an oxygen O.

Conventional composite oxide films generally have a thickness of at least about 1 μm (1000 nm). In contrast, the composite oxide film of the present invention has a thickness of at most 500 nm. Thus, the composite oxide film of the invention is significantly thinner than the conventional films, and therefore has a lower electric resistance in the thickness direction. Consequently, the composite oxide film can be a thin film having an excellent conductivity in the thickness direction. The thin film is suitable as a solid electrolyte.

When the composition ratio of the element A to the element B is 4/3 to 5/3, the composite oxide can be an apatite-type compound. The apatite-type compound has an oxide ion conductivity, whereby the composite oxide film can be used as an oxide ion conductor.

When the composite oxide film contains the apatite-type compound as the composite oxide, the apatite-type compound is preferably in the form of a polycrystal, a c-axis of each crystal grain in the polycrystal being parallel to the thickness direction. The apatite-type compound exhibits a high oxide ion conductivity in the c-axis direction of the unit cell as described below. Therefore, in this case, oxide ions can be readily transferred in the thickness direction.

The composite oxide film is particularly suitable as a solid electrolyte of a solid oxide fuel cell. The power generation property of the solid oxide fuel cell is improved due to the combination of the high oxide ion conductivity and the small thickness (and thus the low electric resistance) of the composite oxide film.

According to another aspect of the present invention, there is provided a method for producing a composite oxide film containing a composite oxide represented by the composition formula of A_{X}B₆O_{1.5X+12} (6≦X≦30) containing a trivalent element A, a tetravalent element B, and an oxygen O.

The method comprises: a first process containing the steps of, onto a substrate, supplying a first material containing one of the elements A and B, supplying an oxidant to form a first layer containing an oxide of the one of the elements A and B, supplying a second material containing the other of the elements A and B, and supplying an oxidant to form a second layer containing an oxide of the other of the elements A and B; a second process containing repeating the steps of the first process to prepare a stack of a plurality of the first layers and a plurality of the second layers; and a third process containing subjecting the substrate and the stack to a heat treatment to produce the composite oxide film containing the A_{X}B₆O_{1.5X+12} (6≦X≦30).

The repetition number ratio between the step of supplying the first material and the step of supplying the second material in the first process is selected to control the composition ratio of the element A to the element B in the composite oxide film.

In this production method, since the first and second materials are each supplied, the thickness of the stack can be easily controlled. Therefore, the composite oxide film containing the A_{X}B₆O_{1.5X+12} (6≦X≦30) can be formed with a desired thickness on the substrate by the above processes.

Furthermore, by selecting the repetition number ratio between the step of supplying the first material and the step of supplying the second material (between the first layer formation and the second layer formation), the A/B composition ratio can be easily controlled in the composite oxide film. Thus, the composition ratio of the composite oxide can be easily controlled to a desired ratio.

As described above, in the present invention, the composite oxide film can be easily produced with a desired composition ratio and a small thickness.

The stack is preferably prepared in the second process such that the composite oxide film has a thickness of 50 to 500 nm after the heat treatment. Practically, the thickness of the stack is approximately equal to that of the composite oxide film. Therefore, for example, in the case of producing the composite oxide film with a thickness of 50 nm, the thickness of the stack may be slightly larger than 50 nm.

In order to obtain an apatite-type compound as the composite oxide, the repetition number ratio between the step of supplying the first material and the step of supplying the second material in the first process may be selected such that the composition ratio of the element A to the element B (the A/B composition ratio) in the composite oxide film is 4/3 to 5/3. The A/B composition ratio in the composite oxide film corresponds to the repetition number ratio. For example, in the case of controlling the A/B composition ratio to 4/3, the repetition number ratio of the step of supplying the material containing the element A to the step of supplying the material containing the element B may be 4/3.

The heat treatment is preferably carried out at a temperature of 800° C. to 1200° C. in the third process. The stack is obtained in the amorphous state and then crystallized by the heat treatment. It inefficiently takes a long time to crystallize the stack in the heat treatment at a temperature of lower than 800° C. It is difficult to perform the heat treatment at a temperature higher than 1200° C. in a case of using a muffle furnace. In general, a heating furnace suitable for the temperature exceeding 1200° C. is expensive, resulting in an increased equipment investment.

The substrate is preferably an Si(100) substrate. On this substrate, particularly in the case of obtaining the apatite-type compound within the above-mentioned heat treatment temperature range, the c-axis is highly likely to be oriented parallel to the thickness direction in the crystal growth. Thus, the composite oxide film containing the oriented apatite-type compound can be easily produced. A cermet substrate containing Ni and a ceramic or a ceramic substrate containing a perovskite-type composite oxide may be used instead of the Si(100) substrate.

The cermet substrate preferably contains a cermet used as a component of an anode in the solid electrolyte fuel cell. Specific examples of the cermets include those of Ni and yttria-stabilized zirconia, Ni and scandia-stabilized zirconia, Ni and yttrium-doped ceria, Ni and gadolinium-doped ceria, or Ni and samarium-doped ceria.

The perovskite-type composite oxide may be preferably the same as a component of a cathode in the solid electrolyte fuel cell. Specific preferred examples of the perovskite-type composite oxides include BaₓSr₁₋ₓCo_{y}Fe_{1-y}O₃, LaₓSr₁₋ₓCoO₃, and LaₓSr₁₋ₓCo_{y}Fe_{1-y}O₃.

In a related art, a film material is supplied onto a substrate from a shower head nozzle having a plurality of regularly arranged outlets. In this case, the film is formed at a higher speed in the positions of the substrate corresponding to the outlets (from which the film material is emitted). Meanwhile, the film is formed at a lower speed in the positions of the substrate corresponding to the closed portions between the outlets (from which the film material is not emitted). Therefore, the resultant film tends to have a spot pattern. In other words, the film is often made uneven.

In view of solving this problem, it is preferred that the first material, the second material, and the oxidant are flowed only in one direction parallel to an upper outer surface of the substrate. In this case, the stack can be prepared with an approximately uniform thickness regardless of the position and surface shape of the substrate.

Even when the substrate has a surface roughness, the composite oxide film can be produced with an approximately uniform thickness by controlling the material flow directions in this manner. In the case of using this composite oxide film as the solid electrolyte in the solid oxide fuel cell, an increased number of contact points are formed between the solid electrolyte and the anode, cathode, or intermediate layer, whereby the charge transfer paths is increased.

Consequently, in this case, the power generation property of the solid oxide fuel cell can be further improved.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic longitudinal sectional view of a composite oxide film according to an embodiment of the present invention immediately after the production;

FIG. 2 is a schematic structural view of a unit cell of an apatite-type compound;

FIG. 3 is a schematic structural view of an atomic layer deposition (“ALD”) apparatus for producing the composite oxide film;

FIG. 4 is a schematic side view of a principal part of a main chamber in the ALD apparatus of FIG. 3;

FIG. 5 is a graph showing a relationship between a repetition number ratio of an La source supplying step to an Si source supplying step (an La/Si supply number ratio) on the abscissa and a composition ratio of La to Si in the resultant composite oxide film (an La/Si composition ratio) on the ordinate;

FIG. 6 is an X-ray diffraction profile of a stack containing an La₂O₃ layer (first layer) and an SiO₂ layer (second layer); and

FIG. 7 is an X-ray diffraction profile of a film produced by subjecting the stack to a heat treatment.

### DESCRIPTION OF THE PREFERRED EMBODIMENTS

A preferred embodiment of the composite oxide film and the production method of the present invention will be described in detail below with reference to accompanying drawings.

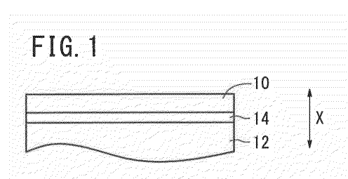

FIG. 1 is a schematic longitudinal sectional view of a composite oxide film 10 according to this embodiment immediately after the production. In this embodiment, the composite oxide film 10 is formed on an Si(100) substrate 12. An SiO₂ layer 14 having an extremely small thickness is interposed between the Si(100) substrate 12 and the composite oxide film 10. As is well known, the Si(100) substrate 12 is a silicon substrate having a (100) surface. This kind of silicon substrate is easily available on the market.

The composite oxide film 10 formed on the SiO₂ layer 14 is composed of a composite oxide containing a trivalent element A, a tetravalent element B, and an oxygen O, represented by the composition formula of A_{X}B₆O_{1.5X+12}. In this formula, X is a numerical value of 6 to 30. The composite oxide cannot be obtained with X of less than 6 or more than 30.

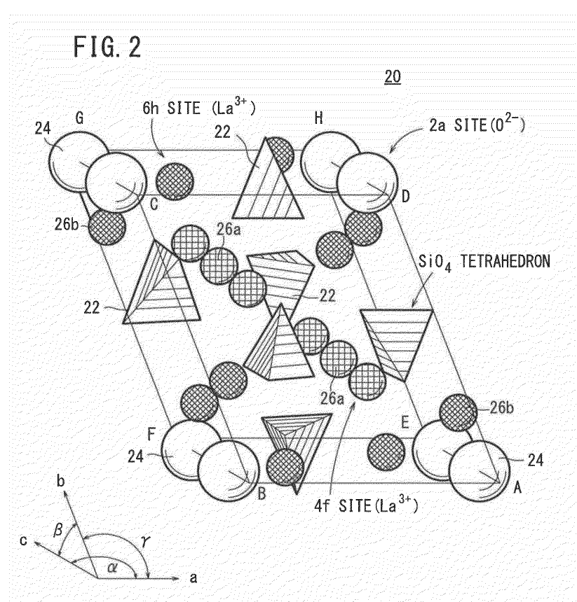

In the case of using the composite oxide film 10 as a solid electrolyte in a solid oxide fuel cell, the composite oxide is preferably an apatite-type compound. The apatite-type compound exhibits a high oxide ion conductivity in the c-axis direction of the unit cell as described above, and thereby is suitable for the solid electrolyte. The apatite-type compound is defined as a compound having a crystal structure shown in FIG. 2.

In the case of generating the apatite-type compound, X is controlled within a range of 8 to 10, and thus the composition ratio of the element A to the element B (the A/B composition ratio) is 4/3 to 5/3. When X is less than 8, the composite oxide is hardly obtained as an apatite-type compound, or alternatively the composite oxide contains an impurity phase of A₂B₂O₇, etc. On the other hand, when X is more than 10, the composite oxide contains an impurity phase of A₂BO₅, etc. In either event, the composite oxide exhibits a lowered oxide ion conductivity.

The element A is a trivalent element, and the element B is a tetravalent element. When X is 8 to 10, the apatite-type compound can be obtained with an excellent oxide ion conductivity. Therefore, the element A is preferably a rare-earth element, particularly La, and the element B is preferably Si or Ge. X is more preferably 9 to 10 to reliably obtain the apatite-type compound. When the element B is Ge, X is preferably at least 8 and less than 10.

X is most preferably 9.33. In this case, the composite oxide crystal has an apatite-type structure (see FIG. 2), an impurity phase having another structure is hardly formed, and the apatite-type compound exhibits a highest oxide ion conductivity.

When the element A is La and the element B is Si, the apatite-type compound of the composite oxide is La_{X}Si₆O_{1.5X+12} (8≦X≦10). The unit cell structure of the La_{X}Si₆O_{1.5X+12} observed in the c-axis direction is shown in FIG. 2. The unit cell 20 has an apatite-type structure containing six SiO₄ tetrahedrons 22, O²⁻ ions 24 occupying 2a sites, and La³⁺ ions 26a and 26b occupying the 4f and 6h sites. Si⁴⁻ and O²⁻ ions in the SiO₄ tetrahedrons 22 are not shown.

The unit cell 20 has a hexagonal system. Thus, in the unit cell 20 shown in FIG. 2, the angle α between the side AB in the a-axis direction and the side BF in the c-axis direction, the angle β between the side BC in the b-axis direction and the side BF, and the angle γ between the sides AB and BC are 90°, 90°, and 120°, respectively. The sides AB and BC have the same length larger than that of the side BF.

The hexagonal lattice (not shown) including the unit cell 20 is a primitive cell. When the hexagonal lattice is rotated ⅓ revolution about an imaginary helical axis (not shown) and is translationally moved by ½ of the length of the side BF along the helical axis, the ion positions after the motion corresponds to those before the motion. In addition, the helical axis is perpendicular to the mirror symmetry plane of the hexagonal lattice. Thus, the crystal of the La_{X}Si₆O_{1.5X+12} (8≦X≦10) has a space group of P6₃/m in the Hermann-Mauguin notation.

Even when the La is replaced with another trivalent element such as another rare-earth element and when the Si is replaced with another tetravalent element such as Ge, the unit cell has the same structure as above.

When the c-axis direction is parallel to the thickness direction of the composite oxide film 10 (the apatite-type compound) and thus the arrow X direction shown in FIG. 1, the resultant solid electrolyte film can exhibit an excellent oxide ion conductivity in the thickness direction.

The composite oxide film 10 has a thickness of 50 to 500 nm. Though conventional composite oxide films generally have a thickness of at least about 1 μm (1000 nm), the composite oxide film 10 of this embodiment has the significantly smaller thickness. Therefore, the composite oxide film 10 has a lower resistance in the thickness direction. Consequently, the composite oxide film 10 can be used as the solid electrolyte with a low IR loss in the solid oxide fuel cell.

The composite oxide film 10 can be produced with a thickness of less than 50 nm. However, in this case, the composite oxide film 10 is easily peeled off from the Si(100) substrate 12. If not peeled off, the composite oxide film 10 is often cracked or short-circuited. Therefore, it is difficult to practically make use of such a composite film with a smaller thickness. Meanwhile, it takes a long time to produce the composite oxide film 10 with a thickness of more than 500 nm.

Next, a method according to this embodiment for producing the composite oxide film 10 will be described below.

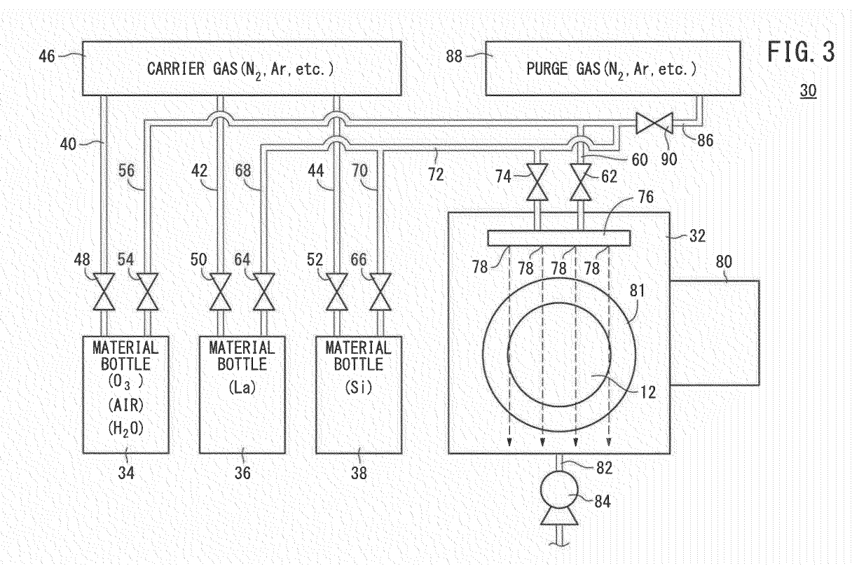

FIG. 3 is a schematic structural view of an atomic layer deposition (ALD) apparatus 30 for producing the composite oxide film 10. In the ALD apparatus 30, a first material bottle 34, a second material bottle 36, and a third material bottle 38 are connected to a main chamber 32. A top view of the main chamber 32 is shown in FIG. 3.

An example of generating the La_{X}Si₆O_{1.5X+12} for the composite oxide film 10 will be described below. The first material bottle 34, the second material bottle 36, and the third material bottle 38 are connected to a carrier gas supply source 46 by a first gas inlet pipe 40, a second gas inlet pipe 42, and a third gas inlet pipe 44, respectively. The carrier gas is inactive against La and Si sources to be hereinafter described, and is preferably a nitrogen (N₂) gas, which is inexpensive and available in a large amount. Another inert gas such as an argon (Ar) gas may be used instead of the nitrogen gas.

A first inlet valve 48, a second inlet valve 50, and a third inlet valve 52 are formed on the first gas inlet pipe 40, the second gas inlet pipe 42, and the third gas inlet pipe 44, respectively. Of course, the first inlet valve 48, the second inlet valve 50, and the third inlet valve 52 can be separately opened and closed.

In this embodiment, an oxidant used as an oxidation source, tris(isopropylcyclopentadienyl)lanthanon, and tris(dimethylamino)silane are contained in the first material bottle 34, the second material bottle 36, and the third material bottle 38, respectively.

The oxidant is preferably ozone, oxygen, air, H₂O (water vapor), or the like. The ozone is capable of efficiently oxidizing the tris(isopropylcyclopentadienyl)lanthanon and the tris(dimethylamino)silane. The oxygen, air, and H₂O are capable of producing the composite oxide film 10 with lower cost.

The tris(isopropylcyclopentadienyl)lanthanon and the tris(dimethylamino)silane are represented by the following structural formulae (1) and (2), respectively.

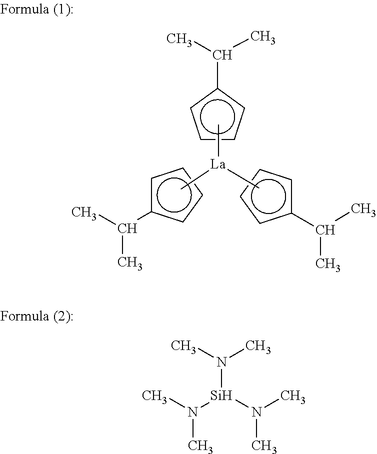

As is clear from the formulae (1) and (2), the tris(isopropylcyclopentadienyl)lanthanon is used as an La source, and the tris(dimethylamino)silane is used as an Si source. Both the substances are in the liquid states at ordinary temperature and pressure.

A first material supply pipe 56 having a first outlet valve 54 is connected to the first material bottle 34. The first material supply pipe 56 joins an oxidant supply pipe 60 linked to the main chamber 32. The oxidant supply pipe 60 has an oxidant outlet valve 62.

A second material supply pipe 68 having a second outlet valve 64 and a third material supply pipe 70 having a third outlet valve 66 are connected to the second material bottle 36 and the third material bottle 38, respectively. The second material supply pipe 68 and the third material supply pipe 70 join each other downstream of the second outlet valve 64 and the third outlet valve 66. A joined supply pipe 72 is formed in the downstream side of the joining of the second material supply pipe 68 and the third material supply pipe 70. The joined supply pipe 72 has a material outlet valve 74.

The first material supply pipe 56 and the joined supply pipe 72 are connected to a purge gas supply source 88 by a purge gas supply pipe 86. The purge gas is inactive against the La source of the tris(isopropylcyclopentadienyl)lanthanon and the Si source of the tris(dimethylamino)silane, and is preferably a nitrogen (N₂) gas, which is inexpensive and available in a large amount, as well as the above-mentioned carrier gas. Another inert gas such as an argon (Ar) gas may be used instead of the nitrogen gas.

A purge gas outlet valve 90 is formed between the first material supply pipe 56, the joined supply pipe 72, and the purge gas supply pipe 86. Of course, the purge gas outlet valve 90 can be opened and closed separately from the above described valves 48, 50, 52, 54, 62, 64, 66, and 74.

The oxidant supply pipe 60 and the joined supply pipe 72 are connected to a distribution nozzle 76 placed in the main chamber 32. On the distribution nozzle 76, a plurality of outlets 78 are formed on the side facing the inside of the main chamber 32. Thus, in the main chamber 32, the tris(isopropylcyclopentadienyl)lanthanon and the tris(dimethylamino)silane are approximately horizontally flowed from the distribution nozzle 76 toward a discharge pipe 82 to be hereinafter described.

A load lock chamber 80 for positioning the Si(100) substrate 12 is disposed on the main chamber 32. The Si(100) substrate 12 is transported from the load lock chamber 80 into the main chamber 32. A heating means such as a heater (not shown) is formed in a substrate holder 81 in the main chamber 32, whereby the Si(100) substrate 12 can be heated.

The discharge pipe 82 is connected to the main chamber 32. The discharge pipe 82 has a vacuum pump 84, and the internal pressure of the main chamber 32 can be lowered to about 10⁻¹ to 10⁻³ Pa by the vacuum pump 84.

In this structure, the first inlet valve 48, the second inlet valve 50, the third inlet valve 52, the first outlet valve 54, the oxidant outlet valve 62, the second outlet valve 64, the third outlet valve 66, the material outlet valve 74, the purge gas outlet valve 90, and the vacuum pump 84 are electrically connected to a control circuit (not shown).

In the production of the composite oxide film 10, the Si(100) substrate 12 is placed in the load lock chamber 80 and then is moved to the substrate holder 81 in the main chamber 32. The Si(100) substrate 12 is heated to a predetermined temperature by the heating means. Meanwhile, the internal air of the main chamber 32 is evacuated by the vacuum pump 84 into a predetermined negative pressure state (vacuum state).

Then, under the control of the control circuit, the second inlet valve 50 is opened, the carrier gas is supplied to the second material bottle 36, and the second outlet valve 64 and the material outlet valve 74 are opened. Thus, the gas-phase tris(isopropylcyclopentadienyl)lanthanon is flowed from the second material bottle 36 to the second material supply pipe 68 and is introduced through the joined supply pipe 72 to the distribution nozzle 76.

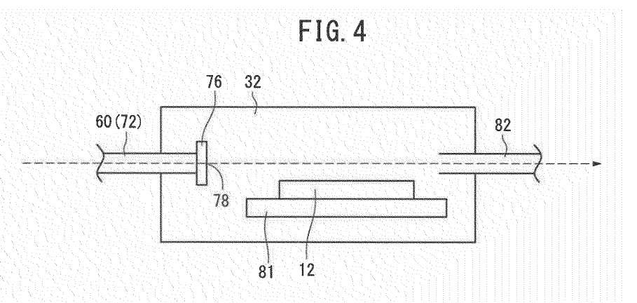

The tris(isopropylcyclopentadienyl)lanthanon is emitted from the plurality of outlets 78 defined in the distribution nozzle 76, and is approximately horizontally flowed from one side wall of the main chamber 32 toward the discharge pipe 82. As shown in FIGS. 3 and 4, the vapor of the tris(isopropylcyclopentadienyl)lanthanon is flowed in a direction parallel to the horizontal upper outer surface of the Si(100) substrate 12. In addition, in this embodiment, the tris(isopropylcyclopentadienyl)lanthanon is flowed only in one direction parallel to the horizontal direction in the main chamber 32.

In this flow step, the tris(isopropylcyclopentadienyl)lanthanon is attached to and deposited on the upper outer surface of the Si(100) substrate 12.

After a predetermined time (about 0.5 to 5 seconds) from the opening of the second inlet valve 50, the second outlet valve 64, and the material outlet valve 74, under the control of the control circuit, the second inlet valve 50 and the second outlet valve 64 are closed, and the purge gas outlet valve 90 is opened. Thus, the purge gas is supplied to the main chamber 32, whereby the tris(isopropylcyclopentadienyl)lanthanon is entrained by the purge gas and discharged from the main chamber 32.

Then, under the control of the control circuit, the purge gas outlet valve 90 is closed, the first inlet valve 48 is opened, and the first outlet valve 54 and the oxidant outlet valve 62 are opened. Thus, the oxidant is introduced from the outlets 78 of the distribution nozzle 76 into the main chamber 32. In the case of using the H₂O as the oxidant, the H₂O may be entrained by the carrier gas supplied to the first material bottle 34. In the case of using the ozone, oxygen, or air as the oxidant, the oxidant may be directly supplied without using the carrier gas.

An example of using the ozone will be described below. The ozone is approximately horizontally flowed in the main chamber 32 from the distribution nozzle 76 toward the discharge pipe 82 in the same manner as the tris(isopropylcyclopentadienyl)lanthanon. In other words, the ozone is flowed in a direction parallel to the upper outer surface of the Si(100) substrate 12. In this flow step, the tris(isopropylcyclopentadienyl)lanthanon attached to the upper outer surface of the Si(100) substrate 12 is oxidized with the ozone, whereby an La₂O₃ layer is formed as a first layer.

After a predetermined time (about 0.5 to 5 seconds) from the opening, the first outlet valve 54 is closed under the control of the control circuit. At the same time, the purge gas outlet valve 90 is opened again, whereby the purge gas is introduced through the oxidant supply pipe 60 and the distribution nozzle 76 into the main chamber 32. The residual tris(isopropylcyclopentadienyl)lanthanon and ozone, not attached to the Si(100) substrate 12 in the main chamber 32, are purged toward the discharge pipe 82 by the introduction of the purge gas.

After the purging is carried out for a predetermined time, the purge gas outlet valve 90 is closed under the control of the control circuit. At the same time, the third outlet valve 66 and the material outlet valve 74 are opened, whereby the gas-phase tris(dimethylamino)silane is flowed from the third material bottle 38 to the third material supply pipe 70 together with the carrier gas, and is introduced through the joined supply pipe 72 to the distribution nozzle 76.

The tris(dimethylamino)silane is emitted from the outlets 78 of the distribution nozzle 76, and is approximately horizontally flowed from one side wall of the main chamber 32 toward the discharge pipe 82. Of course, also in this step, the gas-phase tris(dimethylamino)silane is flowed in a direction parallel to the upper outer surface of the Si(100) substrate 12. In addition, the tris(dimethylamino)silane is flowed only in one direction parallel to the horizontal direction.

In this flow step, the tris(dimethylamino)silane is attached to and deposited on the upper outer surface of the La₂O₃ layer.

After a predetermined time (about 0.5 to 5 seconds) from the opening of the third inlet valve 52, the third outlet valve 66, and the material outlet valve 74, under the control of the control circuit, the third inlet valve 52 and the third outlet valve 66 are closed, and the purge gas outlet valve 90 is opened again. Thus, the purge gas is supplied through the joined supply pipe 72 and the material outlet valve 74 to the distribution nozzle 76, and is introduced from the distribution nozzle 76 into the main chamber 32 again. The residual tris(dimethylamino)silane remaining in the main chamber 32 is purged toward the discharge pipe 82 by the introduction of the purge gas.

After the purging is carried out for a predetermined time, the purge gas outlet valve 90 is closed under the control of the control circuit. At the same time, the first inlet valve 48, the first outlet valve 54, and the oxidant outlet valve 62 are opened, whereby the ozone (oxidant) is flowed from the first material bottle 34 to the first material supply pipe 56. The ozone is introduced through the oxidant outlet valve 62 to the distribution nozzle 76.

The ozone is flowed in a direction parallel to the upper outer surface of the Si(100) substrate 12 in the main chamber 32 in the same manner as above. In this flow step, the tris(dimethylamino)silane is oxidized with the ozone, whereby an SiO₂ layer composed of an Si oxide (a second layer) is formed on the La₂O₃ layer.

Also in this step, after a predetermined time (about 0.5 to 5 seconds) from the opening, the first inlet valve 48 and the first outlet valve 54 are closed under the control of the control circuit. At the same time, the purge gas outlet valve 90 is opened again, whereby the purge gas is introduced through the oxidant supply pipe 60 and the distribution nozzle 76 into the main chamber 32. The residual tris(dimethylamino)silane and ozone, not attached to the Si(100) substrate 12 in the main chamber 32, are purged toward the discharge pipe 82 by the introduction of the purge gas.

In the case of producing the composite oxide film 10 having an La/Si ratio of 1/1 (containing La₂Si₂O₇), the above steps may be repeated to prepare a stack having a predetermined thickness. In this case, the resultant stack contains the La₂O₃ and SiO₂ layers alternately stacked. The repetition number ratio of the steps of supplying the tris(isopropylcyclopentadienyl)lanthanon and the oxidant to the steps of supplying the tris(dimethylamino)silane and the oxidant is 1/1. Thus, the repetition number of the La₂O₃ layer formation is equal to that of the SiO₂ layer formation.

The La₂O₃ and SiO₂ layers may be formed in the reverse order.

In the case of producing the composite oxide film 10 having an La/Si ratio of 5/1 (containing La₅SiO_{9.5}), the repetition number ratio of the steps of supplying the tris(isopropylcyclopentadienyl)lanthanon and the oxidant to the steps of supplying the tris(dimethylamino)silane and the oxidant is 5/1. Thus, for example, two La₂O₃ layers, one SiO₂ layer, and three La₂O₃ layers may be formed in this order in one cycle, and this cycle may be repeated to prepare the stack with a predetermined thickness. Of course, the repetition number ratio of the La₂O₃ layer formation to the SiO₂ layer formation is 5/1.

In the case of obtaining the La_{X}Si₆O_{1.5X+12} as the apatite-type compound, X is preferably 8 to 10. Therefore, the repetition number ratio of the steps of supplying the tris(isopropylcyclopentadienyl)lanthanon and the oxidant to the steps of supplying the tris(dimethylamino)silane and the oxidant is 4/3 to 5/3. In this case, the repetition number ratio of the La₂O₃ layer formation to the SiO₂ layer formation is 4/3 to 5/3.

For example, in the case of producing the composite oxide film 10 having an La/Si ratio of 3/2, the La₂O₃ layer, the SiO₂ layer, the La₂O₃ layer, the SiO₂ layer, and the La₂O₃ layer may be formed in this order in one cycle, and this cycle may be repeated to prepare the stack with a predetermined thickness. In this case, the repetition number ratio of the La₂O₃ layer formation to the SiO₂ layer formation is 3/2.

In any case, the purging is carried out after each step of supplying the material or the oxidant.

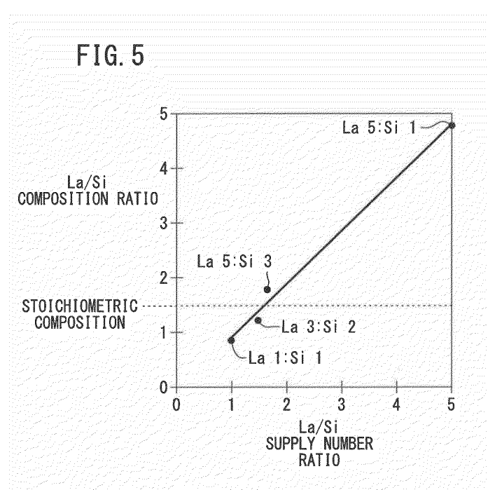

FIG. 5 is a graph showing a relationship between the La/Si supply number ratio on the abscissa and the La/Si composition ratio in the resultant composite oxide film 10 on the ordinate. The La/Si supply number ratio is obtained by dividing the repetition number of the step of supplying the tris(isopropylcyclopentadienyl)lanthanon by the repetition number of the step of supplying the tris(dimethylamino)silane. As is clear from FIG. 5, the La/Si composition ratio of the La_{X}Si₆O_{1.5X+12} in the resultant composite oxide film 10 can be controlled by selecting the La/Si supply number ratio in the above manner.

In conventional ALD apparatuses, a film material is dispersed and supplied from a shower head nozzle located above a substrate. In this case, the film tends to be grown non-uniformly and have unevenness. In contrast, in this embodiment, the materials are supplied in the direction parallel to the upper outer surface of the Si(100) substrate 12. Thus, the film (the stack) can be formed with an approximately uniform thickness regardless of the position. In other words, the film can be produced with a shape corresponding to the surface shape of the Si(100) substrate 12.

The thickness of the stack is selected such that the composite oxide film 10 (the La_{X}Si₆O_{1.5X+12}) has a thickness of 50 to 500 nm after a heat treatment to be hereinafter described. The thickness of the stack may be controlled to a predetermined thickness by repeating the above steps.

The thickness of the stack prepared before the heat treatment is approximately equal to that of the composite oxide film 10 produced by the heat treatment. Therefore, for example, in the case of producing the composite oxide film 10 with a thickness of 50 nm, the thickness of the stack may be slightly larger than 50 nm. Also in the case of producing the composite oxide film 10 with a thickness of 500 nm, the thickness of the stack may be controlled in the same manner.

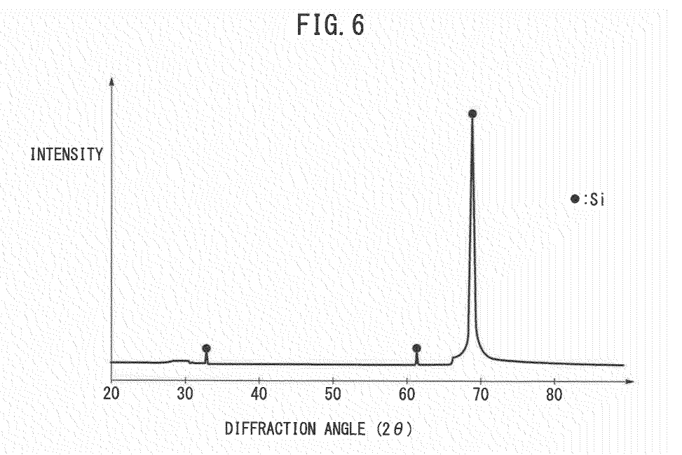

As shown in FIG. 6, in an X-ray diffraction measurement of the stack containing the La₂O₃ and SiO₂ layers, only a peak of the Si(100) substrate 12 is observed. Furthermore, in an observation of the surface and cross-section of the stack using a scanning electron microscope (SEM), grain boundaries are not found in the stack. Therefore, the La₂O₃ and SiO₂ layers may be in the amorphous states at this stage.

Then, the stack is subjected to the heat treatment. In this process, the stack may be placed and heated together with the Si(100) substrate 12 in an appropriate heat treatment furnace such as a muffle furnace. For example, in the heat treatment, the stack may be heated to a temperature of about 800° C. to 1200° C. at a temperature rise rate of 100° C./second and then maintained at the temperature for about 30 minutes to 2 hours.

It takes a long time to crystallize the stack in the heat treatment at a temperature lower than 800° C. Further, it is difficult to perform the heat treatment at a temperature higher than 1200° C. in the muffle furnace. The holding temperature is typically about 1000° C.

In an X-ray diffraction measurement of the heat treated film, in a case where the repetition number ratio of the La₂O₃ layer formation to the SiO₂ layer formation (the La/Si supply number ratio) is 4/3 to 5/3, a peak of the apatite-type compound is observed. Thus, in this case, the X-ray diffraction profile corresponds to the X-ray diffraction pattern of the La_{X}Si₆O_{1.5X+12} (8≦X≦10).

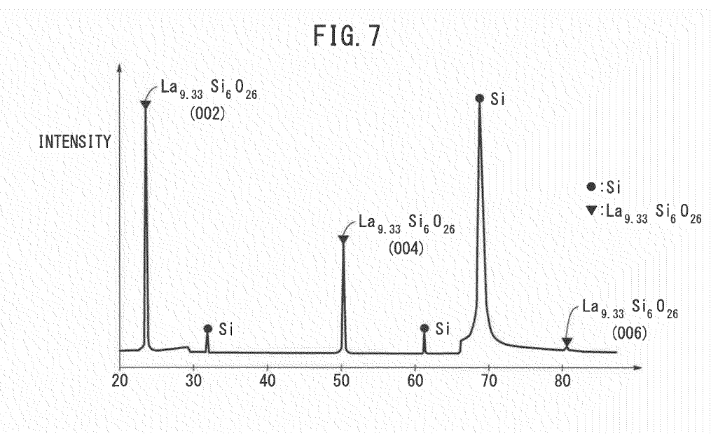

As shown in FIG. 7, particularly in an X-ray diffraction pattern of the film produced at the La/Si supply number ratio of 3/2, peaks of (002) and (004) surfaces of La_{9.33}Si₆O₂₆ are observed. Thus, it is clear that the composite oxide film 10 containing the crystallized La_{9.33}Si₆O₂₆ can be produced, the c-axis of the unit cell being oriented parallel to the thickness direction.

In an electron diffraction of a cross-section of this composite oxide film 10, it is clear from the spot pattern that the (002) surface is aligned in a direction parallel to the Si(100) substrate 12. This fact also supports that the orientation of the c-axis of the unit cell is oriented parallel to the thickness direction.

In a lattice spacing measurement of the cross-section of the composite oxide film 10, the lattice spacing is 9.3 angstroms in the a-axis and b-axis directions and is 7.0 angstroms in the c-axis direction. The measured values are close to the lattice spacing of the La_{9.33}Si₆O₂₆ (9.71280 and 7.18580 angstroms). Also this fact suggests the existence of the La_{9.33}Si₆O₂₆ in the composite oxide film 10.

In an SEM observation of the heat-treated film, a grain boundary is found on the cross-section and outer surface. Therefore, the composite oxide film 10 is in the form of a polycrystal. The composite oxide film 10 has a grain diameter of about 10 to 1000 nm.

As described above, the composite oxide film 10, which has the small thickness and contains the apatite-type compound with the c-axis oriented parallel to the thickness direction, is suitable as the solid electrolyte of the solid oxide fuel cell. The apatite-type compound exhibits an excellent oxide ion conductivity in the c-axis direction, whereby the oxide ions can be readily transferred from the cathode to the anode, resulting in high reaction efficiency. The composite oxide film 10 has a low resistance because of the small thickness of 50 to 500 nm. Therefore, the solid oxide fuel cell exhibits an improved power generation property.

A surface energy of a crystalline compound depends on the plane index. In a hexagonal crystal, the surface energy is lowest on the (001) surface. In the apatite-type compound having the hexagonal system, the c-axis direction corresponding to the (001) surface may be preferentially oriented parallel to the thickness direction.

In general, in an epitaxial growth utilizing a crystal orientation of a substrate surface, it is necessary to strictly control the crystal state of the substrate. In contrast, in this embodiment, the apatite-type compound can be oriented on the amorphous oxide layer (the SiO₂ layer 14) formed on the Si(100) substrate 12. Thus, the apatite-type compound can be oriented in the c-axis direction without strictly controlling the crystal state of the substrate.

It is assumed that, in the heat treatment, the crystals of the apatite-type compound are grown from nuclei generated on a boundary of the amorphous oxide layer (the SiO₂ layer 14) along the (001) surface having the lowest surface energy (i.e. the c-axis).

Therefore, another substrate may be used instead of the Si(100) substrate 12. For example, a component, conventionally used in the anode or cathode of the solid oxide fuel cell, may be used in the substrate for the composite oxide film 10.

Typical examples of the anode components include cermets of Ni and yttria-stabilized zirconia (YSZ), Ni and scandia-stabilized zirconia (SSZ), Ni and yttrium-doped ceria (YDC), Ni and gadolinium-doped ceria (GDC), or Ni and samarium-doped ceria (SDC).

Typical examples of the cathode components include perovskite-type composite oxides such as BaₓSr₁₋ₓCo_{y}Fe_{1-y}O₃ (BSCF), LaₓSr₁₋ₓCoO₃ (LSC), and LaₓSr₁₋ₓCo_{y}Fe_{1-y}O₃ (LSCF).

It is to be understood that the present invention is not particularly limited to the above-described embodiment, and various changes and modifications may be made therein without departing from the scope of the invention.

For example, though the composite oxide film 10 containing the apatite-type compound suitable as the solid electrolyte (the oxide ion conductor) is mainly described in the above embodiment, the present invention includes the composite oxide films with a thickness of 50 to 500 nm containing the La_{X}Si₆O_{1.5X+12} (6≦X≦30). It is to be understood that the composite oxide film 10 containing the apatite-type compound may be used for another purpose.

In addition, though the La_{X}Si₆O_{1.5X+12} is generated as the A_{X}B₆O_{1.5X+12} in the above embodiment (particularly in the production method), the La may be replaced with another trivalent element such as another rare-earth element, and the Si may be replaced with another tetravalent element such as Ge. For example, also in this case, an organic compound stable at ordinary temperature and pressure may be used as a supply source for the trivalent or tetravalent element.

What is claimed is:

1. A composite oxide film comprising a composite oxide represented by the composition formula of A_{X}B₆O_{1.5X+12} (6≦X≦30) containing a trivalent element A, a tetravalent element B, and an oxygen O,
the composite oxide film having a thickness of 50 to 500 nm.

2. The composite oxide film according to claim 1, wherein the composite oxide comprises an apatite-type compound, and the composition ratio of the element A to the element B in the apatite-type compound is 4/3 to 5/3.

3. The composite oxide film according to claim 2, wherein the apatite-type compound is in the form of a polycrystal, and a c-axis of each crystal grain in the polycrystal is parallel to a thickness direction of the composite oxide film.

4. A method for producing a composite oxide film containing a composite oxide represented by the composition formula of A_{X}B₆O_{1.5X+12} (6≦X≦30) containing a trivalent element A, a tetravalent element B, and an oxygen O,
the method comprising:
a first process containing the steps of, onto a substrate, supplying a first material containing one of the elements A and B, supplying an oxidant to form a first layer containing an oxide of the one of the elements A and B, supplying a second material containing another of the elements A and B, and supplying an oxidant to form a second layer containing an oxide of the other of the elements A and B,
a second process containing repeating the steps of the first process to prepare a stack of a plurality of first layers and a plurality of second layers, and
a third process containing subjecting the substrate and the stack to a heat treatment to produce the composite oxide film containing the A_{X}B₆O_{1.5X+12} (6≦X≦30),
wherein the repetition number ratio between the step of supplying the first material and the step of supplying the second material of the first process is selected to control the composition ratio of the element A to the element B in the composite oxide film.

5. The method according to claim 4, wherein the stack is prepared in the second process in such a manner that the composite oxide film produced in the third process has a thickness of 50 to 500 nm.

6. The method according to claim 4, wherein the repetition number ratio between the step of supplying the first material and the step of supplying the second material in the first process is selected in such a manner that the composite oxide is an apatite-type compound, and a composition ratio of the element A to the element B in the apatite-type compound is 4/3 to 5/3.

7. The method according to claim 4, wherein the heat treatment is carried out at a temperature of 800° C. to 1200° C. in the third process.

8. The method according to claim 4, wherein the substrate comprises an Si(100) substrate, a cermet substrate containing Ni and a ceramic, or a ceramic substrate containing a perovskite-type composite oxide.

9. The method according to claim 8, wherein the cermet substrate contains a cermet of Ni and yttria-stabilized zirconia, Ni and scandia-stabilized zirconia, Ni and yttrium-doped ceria, Ni and gadolinium-doped ceria, or Ni and samarium-doped ceria, and the perovskite-type composite oxide is BaₓSr₁₋ₓCo_{y}Fe_{1-y}O₃, LaₓSr₁₋ₓCoO₃, or LaₓSr₁₋ₓCo_{y}Fe_{1-y}O₃.

10. The method according to claim 4, wherein the first material, the second material, and the oxidant are flowed only in one direction parallel to an upper outer surface of the substrate.
